(19) United States
(12) Patent Application Publication
(10) Pub. No.: US 2019/0028432 A1
(43) Pub. Date: Jan. 24, 2019

(54) Domain name shared registering method and system oriented to unified scheduling and management

(71) Applicant: CHINA INTERNET NETWORK INFORMATION CENTER, Beijing (CN)

(72) Inventors: Xiaodong Li, Beijing (CN); Yukun Liu, Beijing (CN); Yuedong Zhang, Beijing (CN); Junfeng Yu, Beijing (CN); Feng Leng, Beijing (CN)

(21) Appl. No.: 16/069,277

(22) PCT Filed: Dec. 23, 2016
(86) PCT No.: PCT/CN2016/111787

§ 371 Date: Jul. 11, 2018

(30) Foreign Application Priority Data
Jan. 22, 2016 (CN) 201610045368.9

(51) Int. Cl. H04L 29/12; H04L 12/863

(52) U.S. Cl. CPC H04L 61/302; H04L 47/62

(57) ABSTRACT

The present invention relates to a shared domain-name registration method and system for unified scheduling and management. A unified authentication unit receives registration request for domain-name registration from domain-name registration service providers, and verifies the registration requests. After verification is successful, a registration messages are sent to a corresponding message queue in a forwarding control unit. The forwarding control unit provides the message queue to the domain-name registration service providers and delivers the registration messages in the message queue to a registration processing unit for processing, wherein the domain-name registration is implemented. A scheduling and management unit monitors request flows from the domain-name registration service providers and the processing status of the registration processing units. The registration processing units are scheduled and managed according to the changes in the request flows from the domain-name registration service providers. The invention can ensure the service quality and controllability of the domain name shared data registration system. The capacity of a service pool for processing shared data at the back-end can be flexibly scaled, thereby facilitating centralized management and control.

### TECHNICAL FIELD

The invention relates to the field of computer networks, and in particular, to a shared data registration technology for a domain-name registration system.

### BACKGROUND OF THE INVENTION

A domain-name registration system is an important infrastructure of the Internet. It is mainly responsible for the registration and management of domain names. When a user of the registrar applies for a new domain name, it needs to create and manage the domain name data through the domain-name registration system of the registrar.

Existing domain registration systems using substantially traditional client-server architecture model. The registrars (client) and the domain-name registration system (server) communicate via the RFC standards. The registration requests are distributed by a load balancing device at the front end of the external domain-name registration system based on load balancing policy. Such approach has the following drawbacks:

a) It is unable to perform unified authority authentication and channel management on the registrar;

b) The scheduling algorithm for load balancing equipment can only control traffic based on the source IP address or the number of back-end connections, but can not control scheduling of the overall traffic volume to the registrar;

c) A connection management mechanism based on static data table can not achieve unified control connections to the registrar, which leads to a large number of connection requests to registrar to load onto the less powerful server registration servers, especially during the peak hours of the registration request traffic; and

d) The synchronous logging mechanism can cause slow down of the domain-name registration system, which is detrimental to registration efficiency.

### SUMMARY OF THE INVENTION

The object of the present invention is to provide methods and systems for data shared domain-name registration. The methods and systems can accomplish the following:

1) Unified authentication and channel management is provided for registration service providers that register domain names via shared data processing.

2) Domain-name registration service providers are categorized into different levels of service sizes or cooperation levels. Based on these levels, the disclosed systems and methods schedule registration requests and control the length of its request queue and the amount of accessible registration resources at the back end.

3) All shared data request logs are recorded collectively and asynchronously, which improves system processing performance.

4) The service quality and controllability are assured in the shared data domain-name registration system, so that the capacity of the service resources for backend shared data processing can be flexibly scaled to facilitate centralized management and control.

To achieve the above purposes, the technical solution adopted by the present invention is as follows:

A method for domain name shared registration with unified scheduling and management includes the following steps:

1) receiving, by a unified authentication unit, registration requests respectively from domain-name registration service providers, and verifying a registration request of the domain-name service provider, sending a registration message to a corresponding message queue in a forwarding control unit;

2) providing a message queue to the one of the domain-name registration service providers by the forwarding control unit, sending the registration message in the message queue to one of registration processing units for processing, and registering a domain name associated with the registration request; and

3) monitoring request flows from the domain-name registration service providers and the processing status of the registration processing units by a scheduling and management unit, scheduling and managing the registration processing units according to changes in the request flows from the domain-name registration service providers.

Further, the forwarding control unit is notified by the scheduling and management unit when detecting an increase in a request flow from one of the domain-name registration service providers. The message queue of the one of the domain-name registration service providers is allowed by the forwarding control unit to send registration messages to the registration processing units, to achieve dynamic capacity expansion of registration processing. When the request flow from one of the domain-name registration service providers decreases, the forwarding control unit is notified by the scheduling and management unit to bundle the request flow to a limited set of registration processing units, to save resource of the registration processing units.

Further, the scheduling and management unit performs the detection of the operation status of one of the registration processing units by the scheduling and management unit and instructs the forwarding control unit to stop forwarding registration requests to one of the registration processing units if the registration processing unit is not operating properly.

Further, the method includes receiving a registration request from a newly added registration processing unit by a registration unit, authenticating the newly added registration processing unit, after authentication, notifying the scheduling management unit that the newly added registration processing unit is available, and allocating the registration processing unit by the scheduling and management unit to the corresponding request queue in the forwarding control unit for capacity expansion of registration processing.

Further, the method can record asynchronously and collectively all registration messages in the message queue by a log recording unit.

A system of unified scheduling and management for domain-name shared registration includes a unified authentication unit, a forwarding control unit, a scheduling and management unit, and a registration processing unit.

The unified authentication unit can receive registration requests respectively from domain-name registration service providers, to verify a registration request from one of the domain-name registration service providers.

The forwarding control unit can provide a message queue a message queue to the one of the domain-name registration service providers, and send the registration message in the message queue to one of registration processing units for processing.

The registration processing unit can receive the registration message from the forwarding control unit and register a domain name associated with the registration request.

The scheduling and management unit can monitor request flows from the domain-name registration service providers and processing status of the registration processing units, and to schedule and to manage the registration processing units according to changes in the request flows from the domain-name registration service providers.

Furthermore, the system can include a registration request configured to receive from a newly added registration processing unit, to authenticate the newly added registration processing unit, after authentication, to notify the scheduling management unit that the newly added registration processing unit is available, wherein the scheduling and management unit is configured to allocate the registration processing unit to the corresponding request queue in the forwarding control unit for capacity expansion of registration processing.

Furthermore, the system can include a log recording unit configured to record all registration messages in the message queue asynchronously and collectively.

The key points of the present invention mainly include: 1) in the event of a sudden increase in the request flows from individual domain-name registration service providers, the scheduling control of the registration requests from the domain-name registration service provider can ensure that the processing of registration requests of other domain registration service providers are affected. 2) the number and the lengths of registration request queues can be can dynamically scheduled, to meet the specific needs of individual domain-name registration service providers that require larger processing capacity. 3) The registration processing units processing the request queues can be dynamically scheduled to expand processing capacity in response to the burst traffic of registration requests online. 4) All registration requests can be recorded collectively and asynchronously.

Compared with conventional systems, the presently disclosed system and methods include one or more of the following benefits:

1) A unified access control strategy can be adopted for all domain-name registration service providers.

2) It can take different task scheduling and queue allocation strategies for different domain-name registration service providers. Different domain-name registration service providers are treated with different scheduling policies, equipped with corresponding processing queue, and loaded on to different registration processing units for processing.

3) It can effectively solve the problem that most registration services cannot handle the requests of other domain service providers due to the large number of requests by a few individual domain-name registration service providers; and

4) All domain-name registration requests can be logged asynchronously, alleviating pressure on the back-end registration service resource processing.

### BRIEF DESCRIPTION OF THE DRAWINGS

FIG. 1 is a structural diagram of a request and verification system for providing unified service to domain-name registration service providers according to some embodiments in the present invention.

FIG. 2 is a schematic view of the message queue scheduling and management system according to some embodiments in the present invention.

FIG. 3 is a flowchart for a capacity adjustment method for a registration capacity scheduling and management system according to the present invention.

### DETAILED DESCRIPTION OF IMPLEMENTATIONS

In order to make the above objects, features, and advantages of the present invention more apparent and understandable, the present invention will be further described below through specific embodiments and the accompanying drawings.

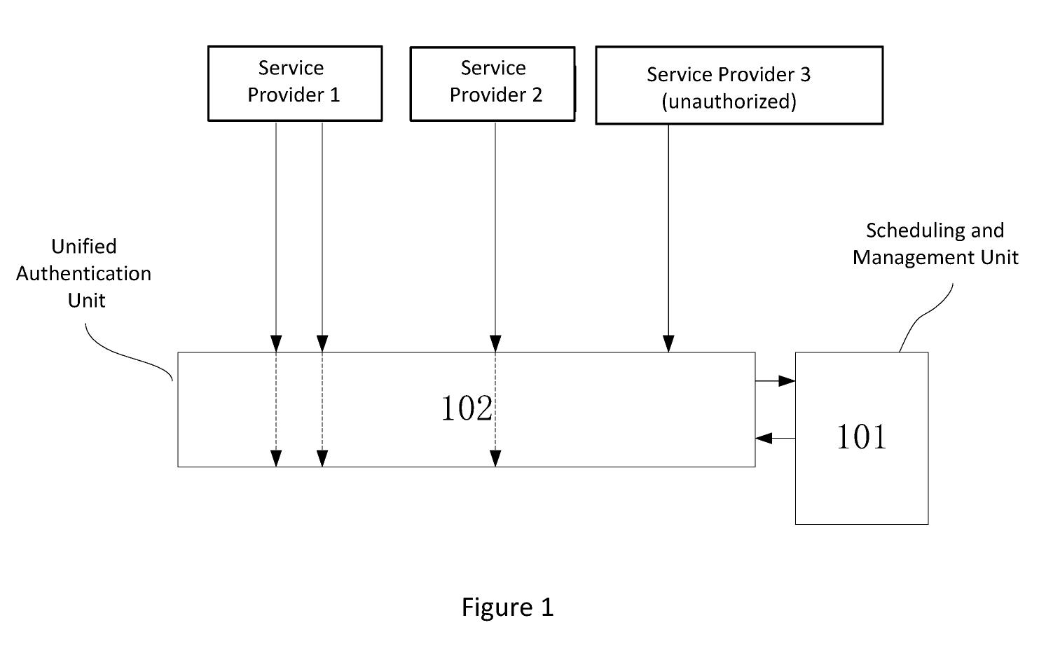

FIG. 1 shows an exemplified request and verification system for providing unified service to domain-name registration service providers according to some embodiments of the present invention. As shown, a request and verification system 1 for providing unified service to domain-name registration service providers includes a scheduling and management unit 101 and a unified authentication unit 102.

Specifically, the unified authentication unit 102 can receive requests from domain-name registration service providers, and verifies the requests from the domain-name registration service providers. That is, the registration requests from domain-name registration service providers are received in a unified fashion; the login authentication, the channel management, and filtering of illegal requests are also conducted in a unified fashion for all domain-name registration service providers. More particularly, after receiving a request from a domain-name registration service provider, the unified authentication unit 102 communicates with the scheduling and management unit 101. The unified authentication unit 102 verifies the authorization certificate of the user and the password of the domain name registrars. The domain name registrar is then allowed to authenticate and establish a trusted encrypted secure connection.

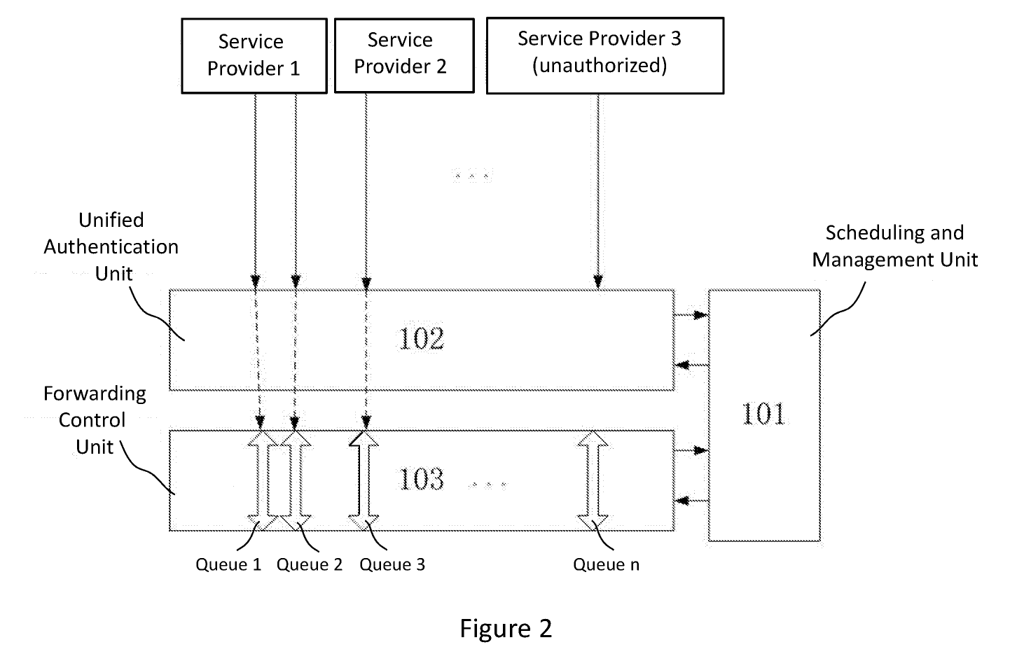

FIG. 2 shows an example of a message queue scheduling and management system in accordance with the present invention. As shown, the message queue scheduling and management system 2 includes a scheduling and management unit 101, a unified authentication unit 102, and a forwarding control unit 103.

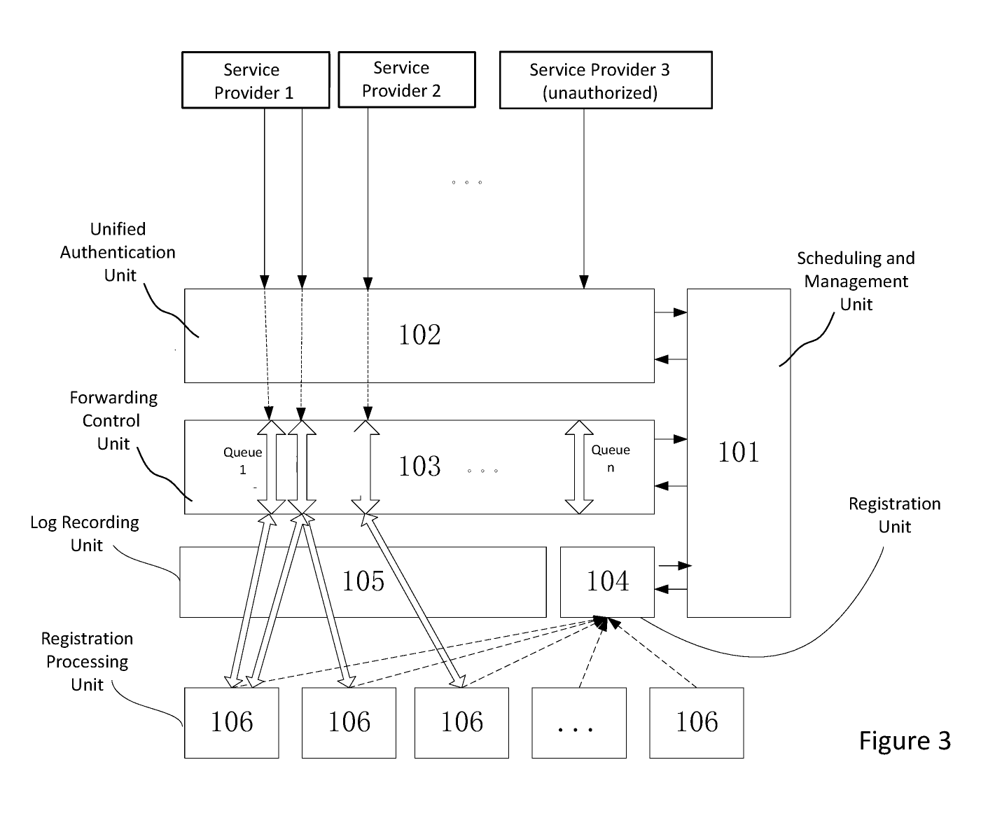

In particular, once the registration request of a domain name registrar is verified, a long connection is established with the request and verification system 1. All the information received in the connection is sent to the corresponding message queue in the forwarding control unit 103. The forwarding control unit 103 sends messages in the message queue to the registration processing unit (i.e., 106 in FIG. 3, described below) at the end of the queue in for processing. The forwarding control unit 103 reports the processing status of each queue to the scheduling and management unit 101.

FIG. 3 shows an example of capacity adjustment of a registration capacity scheduling and management system in accordance to the present invention. As shown in FIG. 3, the capacity scheduling and register management system includes a scheduling and management unit 101, an unified authentication unit 102, a forwarding control unit 103, a registration unit 104, a log recording unit 105, and one or more registration processing units 106. By default, each message queue is equipped with at least one corresponding registration processing unit 106.

In particular, when the messages pending to be processed in the messages queue in the forwarding control unit 103 reach a certain threshold, the forwarding control unit 103 notifies the scheduling and management unit 101, which in turn detects an increased request flow by a domain-name registration service provider, and thus sends a notification to the forwarding control unit 103. The forwarding control unit 103 allows the domain name registrar's message queue to send registration messages to the registration processing units 106. The registration processing units 106 perform domain-name registration, to achieve capacity expansion of registration processing. More specifically, the newly deployed registration processing units 106 initiate a registration request to the registration unit 104. After receiving the request, the registration unit 104 performs a predetermined registration verification logic test kit in the newly deployed registration processing units 106. The predetermined registration validation logic test kit includes various types of basic register commands specified in the RFC. After the verification, the scheduling and management unit 101 is notified that the tested registration processing unit is available. The scheduling and management unit 101 can allocate the processing unit 106 to the corresponding request queue in the forwarding control unit 103 to expand processing capacity. More specifically, the log recording unit 105 is used to asynchronously record all the messages collectively in the request queue, which alleviates processing pressure on the back-end registration service.

Correspondingly, when the registration request traffic from the registration service organization decreases, the scheduling and management unit 101 may also notify the forwarding control unit 103 to bundle the request queue to load onto a limited set of registration processing units 106, which achieves the purpose of saving the resource of registration processing units.

The presently disclosed system and methods greatly improve the design of the conventional shared data domain-name registration system, and completely overcome the drawbacks in channel and traffic management in the conventional shared data domain-name registration systems.

The above embodiments are only used to illustrate the technical solutions of the present invention and are not limited thereto. Those skilled in the art may modify or equivalently substitute the technical solutions of the present invention without departing from the spirit and scope of the present invention. The scope of protection shall be subject to the provisions of the claims.

What is claimed is:

1. A method of unified scheduling and management for domain-name shared registration, comprising:
1) receiving, by a unified authentication unit, registration requests respectively from domain-name registration service providers, verifying a registration request from one of the domain-name registration service providers, and sending a registration message to a corresponding message queue in a forwarding control unit;
2) providing a message queue to the one of the domain-name registration service providers by the forwarding control unit, sending the registration message in the message queue to one of registration processing units for processing, and registering a domain name associated with the registration request; and
3) monitoring request flows from the domain-name registration service providers and the processing status of the registration processing units by a scheduling and management unit, scheduling and managing the registration processing units according to changes in the request flows from the domain-name registration service providers.

2. The method according to claim 1, further comprising:
notifying the forwarding control unit by the scheduling and management unit when detecting an increase in a request flow from one of the domain-name registration service providers;
allowing, by the forwarding control unit, the message queue of the one of the domain-name registration service providers to send registration messages to the registration processing units, to achieve dynamic capacity expansion of registration processing; and
when the request flow from one of the domain-name registration service providers decreases, notifying the forwarding control unit by the scheduling and management unit to bundle the request flow to a limited set of registration processing units, to save resource of the registration processing units.

3. The method according to claim 1, further comprising:
detecting operation status of one of the registration processing units by the scheduling and management unit; and
instructing the forwarding control unit to stop forwarding registration requests to one of the registration processing units if the registration processing unit is not operating properly.

4. The method according to claim 1, further comprising:
receiving a registration request from a newly added registration processing unit by a registration unit;
authenticating the newly added registration processing unit;
after authentication, notifying the scheduling management unit that the newly added registration processing unit is available; and
allocating the registration processing unit by the scheduling and management unit to the corresponding request queue in the forwarding control unit for capacity expansion of registration processing.

5. The method according to claim 1, further comprising:
asynchronously and collectively recording all registration messages in the message queue by a log recording unit.

6. A system of unified scheduling and management for domain-name shared registration, comprising:
a unified authentication unit;
a forwarding control unit;
a scheduling and management unit; and
a registration processing unit,
wherein the unified authentication unit is configured to receive registration requests respectively from domain-name registration service providers, to verify a registration request from one of the domain-name registration service providers, and to send a registration message to a corresponding message queue in a forwarding control unit,
wherein the forwarding control unit is configured to provide a message queue a message queue to the one of the domain-name registration service providers, and to send the registration message in the message queue to one of registration processing units for processing,
wherein the registration processing unit is configured to receive the registration message from the forwarding control unit and to register a domain name associated with the registration request,
wherein the scheduling and management unit is configured to monitor request flows from the domain-name registration service providers and processing status of the registration processing units, and to schedule and to manage the registration processing units according to changes in the request flows from the domain-name registration service providers.

7. The system according to claim 6, wherein the scheduling and management unit is configured to notify the forwarding control unit when detecting an increase in a request flow from one of the domain-name registration service providers,
wherein the forwarding control unit is configured to allow the message queue of the one of the domain-name registration service providers to send registration messages to the registration processing units, to achieve dynamic capacity expansion of registration processing,
wherein when the request flow from one of the domain-name registration service providers decreases, the scheduling and management unit is configured to notify the forwarding control unit to bundle the request flow to a limited set of registration processing units, to save resource of the registration processing units.

8. The system according to claim 6, wherein the scheduling and management unit is configured to detect operation status of one of the registration processing units, and to instruct the forwarding control unit to stop forwarding registration requests to one of the registration processing units if the registration processing unit is not operating properly.

9. The system according to claim 6, further comprising:
a registration unit configured to receive a registration request from a newly added registration processing unit, and to authenticate the newly added registration processing unit,
wherein the registration unit is configured, after authentication, to notify the scheduling management unit that the newly added registration processing unit is available,
wherein the scheduling and management unit is configured to allocate the registration processing unit to the corresponding request queue in the forwarding control unit for capacity expansion of registration processing.

10. The system according to claim 6, further comprising:
a log recording unit configured to asynchronously and collectively recording all registration messages in the message queue.
